(19) United States
(12) Patent Application Publication
(10) Pub. No.: US 2003/0046301 A1
(43) Pub. Date: Mar. 6, 2003

(54) Method and system for the integrated installation of software

(76) Inventors: Burton Leathers, Kanata (CA); Andrew Leikucs, Osgoode (CA)

Correspondence Address: Finnegan, Henderson, Farabow, Garrett & Dunner, L.L.P., 1300 I Street, N.W., Washington, DC, 20005-3315, US

(21) Appl. No.: 09/946,551

(22) Filed: Sep. 6, 2001

(51) Int. Cl. G06F 7/00

(52) U.S. Cl. 707/103 R

(57) ABSTRACT

A method and system for the integrated installation of software. The method includes the steps of discovering program descriptors of computer programs available to be installed and creating a software environment specification having one or more software environment objects, the specification based on the discovered program descriptors. The method further includes the steps of transferring required files from distribution storage onto a computer system for preparation of the software environment and writing parameter values to parameter storage based on the created software environment specification to adapt the installed software to form a software environment. In an embodiment of the present invention, the method further includes the step of evaluating validity conditions for the software environment objects to validate elements of the software environment.

### FIELD OF THE INVENTION

The present invention relates to the installation of computer software, and more particularly to a method and system for the integrated installation of software.

### BACKGROUND OF THE INVENTION

Today's computer programs can require complex installations that require the selecting of parameters critical to smooth program operation.

As well, programs must often be installed in combination with one another, requiring parameter selections that are often crucial to the interoperability of the combined programs.

In addition, programs can require installation on multiple computers, and even more complex installations can involve computers having multiple operating system types and/or differing computer hardware.

Existing installation methods typically either rely on the abilities of the person installing the software in making difficult parameter decisions; largely leaving to chance the proper input of parameters, or attempt to coerce the plurality of programs into becoming a single composite product or suite, to then be installed using standard tools. For diverse technical and commercial reasons, it is not always possible to transform an interoperating set of programs into a suite.

What is needed is a method of installing a plurality of software components required to interact in a coordinated manner that provides for the smooth operation of the interacting components.

For the foregoing reasons, there is a need for an improved method of software installation.

### SUMMARY OF THE INVENTION

The present invention is directed to a method and system for the integrated installation of software. The method includes the steps of discovering program descriptors of computer programs available to be installed and creating a software environment specification having one or more software environment objects, the specification based on the discovered program descriptors.

The method further includes the steps of transferring required files from distribution storage onto a computer system for preparation of the software environment and writing parameter values to parameter storage based on the created software environment specification to adapt the installed software to form a software environment.

In an aspect of the present invention, the method further includes the step of evaluating validity conditions for the software environment objects to validate elements of the software environment.

The system includes an installation engine for performing operational aspects of installation and configuration, one or more program descriptors for characterizing computer programs available to be processed during an invocation of the engine and a software environment specification created based on the one or more program descriptors.

The installation engine includes one or more storage adapters for writing parameter values to parameter storage. The software environment specification includes one or more software environment objects.

In an aspect of the present invention, a program descriptor includes one or more of: a program descriptor general description; a parameter list for indicating parameters that may be set in relation to a computer program; a parameter object group list for applying parameter values in the environment in which a program is installed; and a validity conditions list for indicating conditions to be satisfied.

In an aspect of the present invention, a software environment object is embodied as one of: a computer object representing a computer available to have one or more computer programs to be installed; a computer program object representing a computer program available to be installed; or a parameter object representing parameters for a computer or a computer program.

In an aspect of the present invention, a parameter object further includes one or more of: a parameter object general description; a default value expression; a current actual value; a validity expression object for validity conditions; and a value storage control object for regulating and directing the storage of a parameter value. In an aspect of the present invention, a value storage control object includes one or more of: a storage adapter type; a storage adapter instance identifier; and a storage adapter key to ensure correct value storage.

Since the invention requires no inbuilt knowledge of the nature of the operation of programs it installs, and can employ a very simple property set based user interface, it is easy to create embodiments which can effectively operate on all major computer systems. Furthermore, because the program descriptors are in a generalized markup language such as an XML format, they are portable across a plurality of computer systems.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of a method for the integrated installation of software according to the present invention;

FIG. 2 is an overview of a system for the integrated installation of software according to the present invention;

FIG. 3 shows embodiments of a program descriptor;

FIG. 4 shows embodiments of a software environment object;

FIG. 5 shows embodiments of a parameter object; and

FIG. 6 shows an embodiment of a method for the integrated installation of software including the step of evaluating validity conditions.

### DETAILED DESCRIPTION OF THE PRESENTLY PREFERRED EMBODIMENT

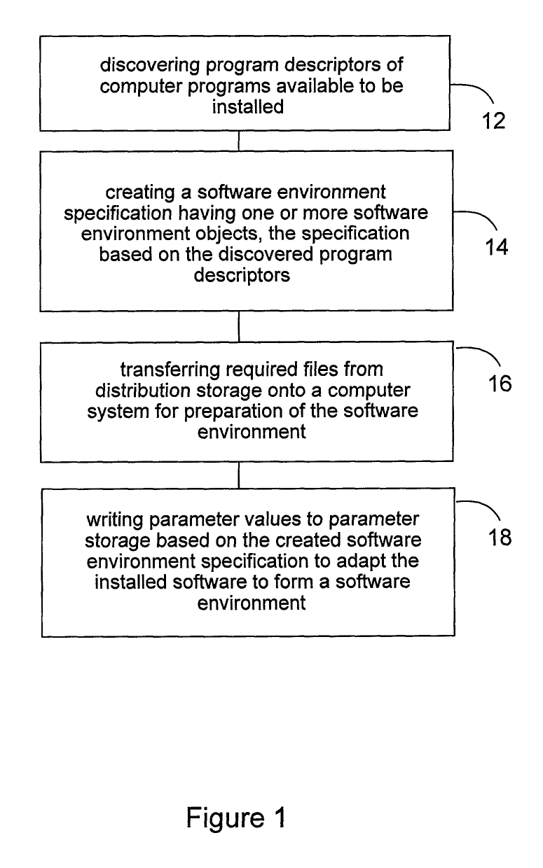

The present invention is directed to a method and system for the integrated installation of software. As shown in FIG. 1, the method includes the steps of discovering program descriptors of computer programs available to be installed 12 and creating a software environment specification having one or more software environment objects, the specification based on the discovered program descriptors 14.

The method further includes the steps of transferring required files from distribution storage onto a computer system for preparation of the software environment 16 and writing parameter values to parameter storage based on the created software environment specification to adapt the installed software to form a software environment 18.

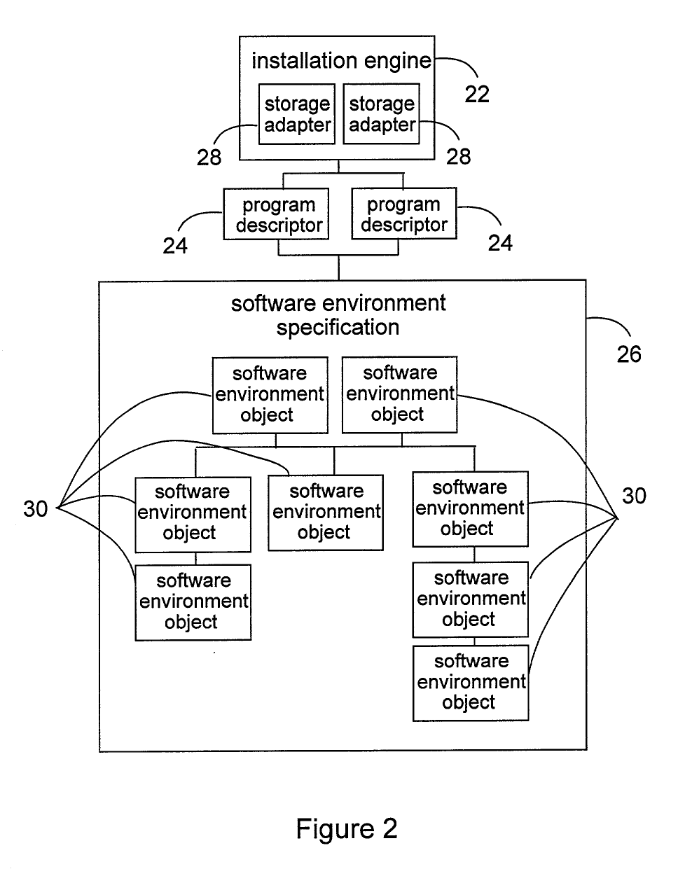

As shown in FIG. 2, the system includes an installation engine 22 for performing operational aspects of installation and configuration, one or more program descriptors 24 for characterizing computer programs available to be processed during an invocation of the engine 22 and a software environment specification 26 created based on the one or more program descriptors 24.

The installation engine 22 includes one or more storage adapters 28 for writing parameter values to parameter storage. The software environment specification 26 includes one or more software environment objects 30.

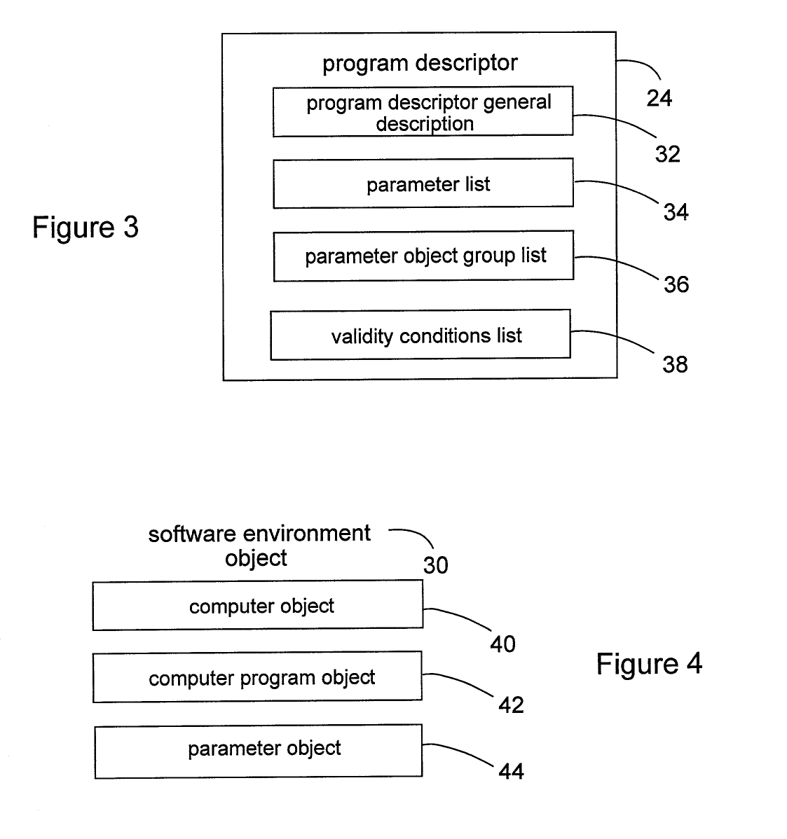

As shown in FIG. 3, in an embodiment of the present invention, a program descriptor 24 includes one or more of: a program descriptor general description 32; a parameter list 34 for indicating parameters that may be set in relation to a computer program; a parameter object group list 36 for applying parameter values in the environment in which a program is installed; and a validity conditions list 38 for indicating conditions to be satisfied.

As shown in FIG. 4, in an embodiment of the present invention, a software environment object 30 is embodied as one of: a computer object 40 representing a computer available to have one or more computer programs installed; a computer program object 42 representing a computer program available to be installed; or a parameter object 44 representing parameters for a computer or a computer program.

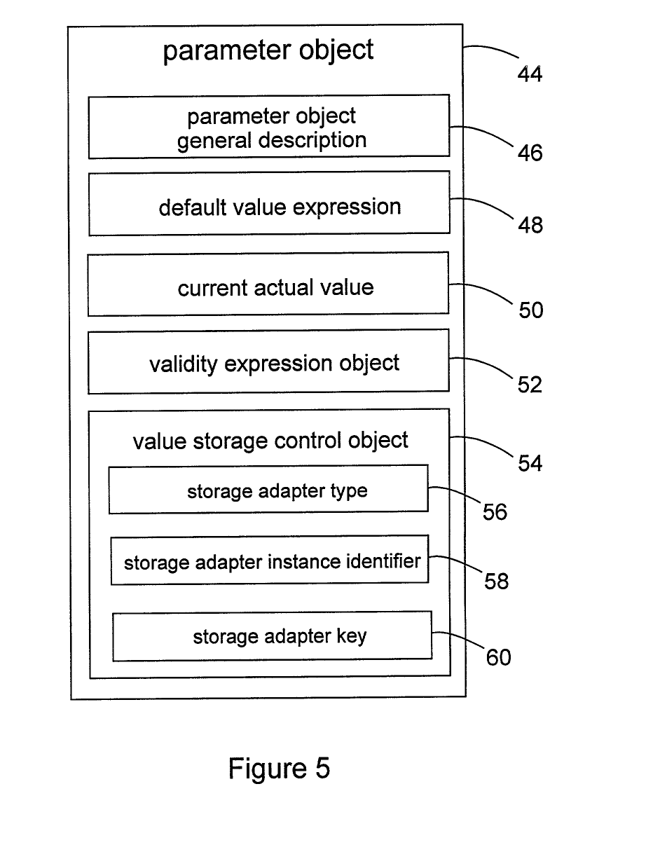

As shown in FIG. 5, in an embodiment of the present invention, a parameter object 44 further includes one or more of: a parameter object general description 46; a default value expression 48; a current actual value 50; a validity expression object 52 for validity conditions; and a value storage control object 54 for regulating and directing the storage of a parameter value. In an embodiment of the present invention, a value storage control object 54 includes one or more of: a storage adapter type 56; a storage adapter instance identifier 58; and a storage adapter key 60 to ensure correct value storage.

The invention operates without specific knowledge of any particular software component. It operates in terms of an abstract functional model that generalizes the tasks performed so as to be independent of any software component. The functions operate upon objects in an abstract data model that generalizes the information required to represent the characteristics of any element affected by the system. The information necessary to process any specific software component is acquired from data resources, which encode any required information in terms of the system's object model.

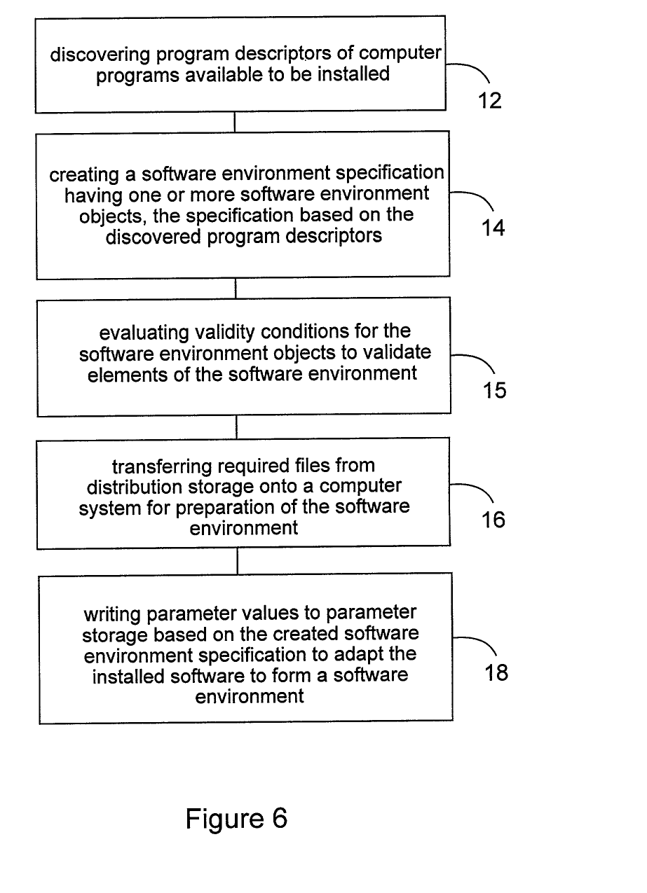

As shown in FIG. 6, in an embodiment of the present invention, the method further includes the step of evaluating validity conditions for the software environment objects to validate elements of the software environment 15. The invention includes validation tools that provide an installer with feedback. Validation rules are used to determine whether the selections and parameter settings, which the user has provided, are workable.

Validation activities are of two types; the first type being consistency checks, which are simply logical predicates that can be evaluated in terms of known data in order to determine that an element of data is logically correct. One of the primary objectives of the invention is to assure configuration definition consistency, employing consistency rules. Consistency rules are objects that contain definitions of logical expressions. For example, it is possible to check dependencies of one computer program upon another to assure that when a specific computer program has been included as part of the software environment specification 26, all computer programs or components upon which it depends have also been included in the specification 26.

The second type of validation activity is a validity check, which determines if a logically valid parameter is also operationally valid in the specific machine environment in which it is to be applied. For example, a file path can be tested to determine if it exists.

In order to apply a software environment specification 26 in its entirety, there must be an ability to write parameter values to appropriate storage structures. In order to simplify the internal structure of the system, the issues associated with processing each of these storage forms is isolated in, and delegated to, a specialized software component called a storage adapter 28. Every parameter processed by the system is associated with a specific storage adapter instance. All storage adapters export the same API for use by the system. The use of a uniform parameter storage interface allows the invention to focus on the value and validity of parameter values, and to remain indifferent to where and how the parameter is actually stored.

Since the invention requires no inbuilt knowledge of the nature of the operation of programs it installs, and can employ a very simple property set based user interface, it is easy to create applications that can effectively operate on all major computer systems. Furthermore, because the program descriptors 24 are in a generalized markup language such as an XML format, they are portable across a plurality of computer systems.

As well, because the invention operates in terms of the application of fixed procedures to statically defined descriptive information rather than using procedural elements that are specific to the software components being processed, it precludes the need for a trained programmer in providing the information necessary to create an integrated installation mechanism for multiple programs.

In an embodiment of the present invention, a program descriptor is provided in the form of a generalized markup language such as an extensible Markup Language (XML) document that describes a software component with which the system is to be able to work, thereby providing a standardized method of encompassing software component parameter information. In an embodiment of the invention, the generalized markup language such as an XML document is structured in a manner that provides for all information that might be displayed to an installer to be represented in multiple languages.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A method for the integrated installation of software comprising the steps of:
(i) discovering program descriptors of computer programs available to be installed;
(ii) creating a software environment specification including one or more software environment objects defined in a hierarchical structure, the specification based on the discovered program descriptors;
(iii) transferring required files from distribution storage onto a computer system for preparation of a software environment; and
(iv) writing parameter values to parameter storage based on the created software environment specification to adapt the installed software to form the software environment.

2. The method according to claim 1, further comprising the step of evaluating validity conditions for the one or more software environment objects to validate elements of the software environment.

3. The method according to claim 1, wherein a program descriptor includes one or more of:
a program descriptor general description;
a parameter list;
a parameter object group list; and
a validity conditions list.

4. The method according to claim 1, wherein a software environment object is embodied as one of:
a computer object;
a computer program object; or
a parameter object.

5. The method according to claim 4, wherein a parameter object further includes one or more of:
a parameter object general description;
a default value expression;
a current actual value;
a validity expression object; and
a value storage control object having:
a storage adapter type;
a storage adapter instance identifier; and
a storage adapter key to ensure correct value storage.

6. The method according to claim 5, wherein the storage adapter receives the current actual value, storage adapter type, storage adapter instance identifier and storage adapter key of a parameter object, and writes the current actual value to the value storage mechanism described by the storage adapter type, instance identifier and key.

7. The method according to claim 5, further including an ability to amend one or more individual current actual values to have a value other than that of the default value expression.

8. The method according to claim 1, wherein a program descriptor is provided in the form of a generalized markup language such as an extensible Markup Language (XML) document that describes a software component with which the system is to be able to work, thereby providing a standardized method of encompassing software component parameter information.

9. The method according to claim 8, wherein the generalized markup language such as an XML document is structured in a manner that provides for all information that might be displayed to an installer to be represented in multiple languages.

10. The method according to claim 4, wherein parameter objects can be grouped together to form a parameter object group.

11. The method according to claim 10, wherein a parameter object group can contain other parameter object groups.

12. A system for the integrated installation of software comprising:
an installation engine for performing operational aspects of installation and configuration, the engine having one or more storage adapters for writing parameter values to parameter storage;
one or more program descriptors for characterizing computer programs available to be processed during an invocation of the engine; and
a software environment specification created based on the one or more program descriptors, the specification including one or more software environment objects.

13. The system according to claim 12, further comprising evaluating validity conditions for the one or more software environment objects to validate elements of a software environment.

14. The system according to claim 12, wherein a program descriptor includes one or more of:
a program descriptor general description;
a parameter list;
a parameter object group list; and
a validity conditions list.

15. The system according to claim 12, wherein a software environment object is embodied as one of:
a computer object;
a computer program object; or
a parameter object.

16. The system according to claim 15, wherein a parameter object further includes one or more of:
a parameter object general description;
a default value expression;
a current actual value;
a validity expression object; and
a value storage control object having:
a storage adapter type;
a storage adapter instance identifier; and
a storage adapter key to ensure correct value storage.

17. The system according to claim 16, wherein the storage adapter receives the current actual value, storage adapter type, storage adapter instance identifier and storage adapter key of a parameter object, and writes the current actual value to the value storage mechanism described by the storage adapter type, instance identifier and key.

18. The system according to claim 16, further including an ability to amend one or more individual current actual values to have a value other than that of the default value expression.

19. The system according to claim 12, wherein a program descriptor is provided in the form of a generalized markup language such as an extensible Markup Language (XML) document that describes a software component with which the system is to be able to work, thereby providing a standardized method of encompassing software component parameter information.

20. The system according to claim 19, wherein the generalized markup language such as an XML document is structured in a manner that provides for all information that might be displayed to an installer to be represented in multiple languages.

21. The system according to claim 15, wherein parameter objects can be grouped together to form a parameter object group.

22. The system according to claim 21, wherein a parameter object group can contain other parameter object groups.

23. A system for the integrated installation of software comprising:
means for discovering program descriptors of computer programs available to be installed;
means for creating a software environment specification including one or more software environment objects, the specification based on the discovered program descriptors;
means for transferring required files from distribution storage onto a computer system for preparation of a software environment; and
means for writing parameter values to parameter storage based on the created software environment specification to adapt the installed software to form the software environment.

24. The system according to claim 23, further comprising means for evaluating validity conditions for the one or more software environment objects to validate elements of the software environment.

25. The system according to claim 23, wherein a program descriptor includes one or more of:
a program descriptor general description;
a parameter list;
a parameter object group list; and
a validity conditions list.

26. The system according to claim 23, wherein a software environment object is embodied as one of:
a computer object;
a computer program object; or
a parameter object.

27. The system according to claim 26, wherein a parameter object further includes one or more of:
a parameter object general description;
a default value expression;
a current actual value;
a validity expression object; and
a value storage control object having:
a storage adapter type;
a storage adapter instance identifier; and
a storage adapter key to ensure correct value storage.

28. The system according to claim 27, wherein the storage adapter receives the current actual value, storage adapter type, storage adapter instance identifier and storage adapter key of a parameter object, and writes the current actual value to the value storage mechanism described by the storage adapter type, instance identifier and key.

29. The system according to claim 27, further including an ability to amend one or more individual current actual values to have a value other than that of the default value expression.

30. The system according to claim 23, wherein a program descriptor is provided in the form of a generalized markup language such as an extensible Markup Language (XML) document that describes a software component with which the system is to be able to work, thereby providing a standardized method of encompassing software component parameter information.

31. The system according to claim 30, wherein the generalized markup language such as an XML document is structured in a manner that provides for all information that might be displayed to an installer to be represented in multiple languages.

32. The system according to claim 26, wherein parameter objects can be grouped together to form a parameter object group.

33. The system according to claim 32, wherein a parameter object group can contain other parameter object groups.

34. A storage medium readable by a computer encoding a computer process to provide a method for the integrated installation of software, the computer process comprising:
a processing portion for discovering program descriptors of computer programs available to be installed;
a processing portion for creating a software environment specification including one or more software environment objects defined in a hierarchical structure, the specification based on the discovered program descriptors;
a processing portion for transferring required files from distribution storage onto a computer system for preparation of a software environment; and
a processing portion for writing parameter values to parameter storage based on the created software environment specification to adapt the installed software to form the software environment.

35. The method according to claim 34, further comprising a processing portion for evaluating validity conditions for the one or more software environment objects to validate elements of the software environment.

36. The method according to claim 34, wherein a program descriptor includes one or more of:
a program descriptor general description;
a parameter list;
a parameter object group list; and
a validity conditions list.

37. The method according to claim 34, wherein a software environment object is embodied as one of:
a computer object;
a computer program object; or
a parameter object.

38. The method according to claim 37, wherein a parameter object further includes one or more of:
a parameter object general description;
a default value expression;
a current actual value;
a validity expression object; and
a value storage control object having:
a storage adapter type;
a storage adapter instance identifier; and
a storage adapter key to ensure correct value storage.

39. The method according to claim 38, wherein the storage adapter receives the current actual value, storage adapter type, storage adapter instance identifier and storage adapter key of a parameter object, and writes the current actual value to the value storage mechanism described by the storage adapter type, instance identifier and key.

40. The method according to claim 38, further including an ability to amend one or more individual current actual values to have a value other than that of the default value expression.

41. The method according to claim 34, wherein a program descriptor is provided in the form of a generalized markup language such as an extensible Markup Language (XML) document that describes a software component with which the system is to be able to work, thereby providing a standardized method of encompassing software component parameter information.

42. The method according to claim 41, wherein the generalized markup language such as an XML document is structured in a manner that provides for all information that might be displayed to an installer to be represented in multiple languages.

43. The method according to claim 37, wherein parameter objects can be grouped together to form a parameter object group.

44. The method according to claim 43, wherein a parameter object group can contain other parameter object groups.
